(19) United States
(12) Patent Application Publication
(10) Pub. No.: US 2008/0216947 A1
(43) Pub. Date: Sep. 11, 2008

(54) Temporary Tatoo for Rubber Tires

(76) Inventor: Rael M. Gilchrist, Hollywood, FL (US)

Correspondence Address: ROBERT M. SCHWARTZ, P.A., P.O. BOX 221470, HOLLYWOOD, FL, 33022, US

(21) Appl. No.: 12/043,315

(22) Filed: Mar. 6, 2008

Related U.S. Application Data
(60) Provisional application No. 60/893,422, filed on Mar. 7, 2007.

(51) Int. Cl. B44C 1/165

(52) U.S. Cl. 156/230; 428/42.1; 428/41.8

(57) ABSTRACT

The present invention is an article and method for applying a moisture transferable image to the surface of a tire, whereby the image retains visual integrity for up to six months.

### INDEX TO RELATED APPLICATIONS

This application claims the benefit of U.S. Provisional Patent Application Ser. No. 60/893,422 filed Mar. 7, 2007, the disclosure of which is incorporated herein by reference in its entirety.

### BACKGROUND OF THE INVENTION

A temporary tattoo is a decorative image that can be applied to the skin for short periods of time. Most temporary tattoos are novelty items made with a special type of decal. A process known as screen printing is used to create the tattoo image on paper coated with a transfer film. The transfer film allows the image to “slide” off the backing paper and onto the skin when moisture is applied. After drying, the film holds the image on the skin through several washings.

For centuries, men and women have added decorative illustrations to their skin for religious or cultural reasons. One common method of decorating skin is tattooing, a process which involves injecting patterns of dye directly into the skin using a needle. Although this technique was originally practiced in ancient Egypt, the term tattoo is actually derived from a Tahitian word that was most likely spread by sailors in the Pacific. Many other cultures have their own unique tattoo techniques. For example, Eskimos use bone needles to draw soot-covered thread through the skin and the Japanese use fine metal needles to deliver colored pigments. Regardless of which technique is used, all tattoo processes deposit colorants below the surface of the skin to create intense, permanent images. While tattooing remains a popular art form today, it is also expensive, time consuming, and may be somewhat painful. For these reasons, permanent tattoos are not necessarily desirable for every individual.

Temporary tattoos were created as an alternative way for individuals to decorate their skin. Temporary images can be produced by several methods. For example, they can be hand drawn and painted using a brush with water insoluble dyes or pigments. Although this method requires a talented artist to create a high quality image, it does produce a picture which can be removed fairly easily. A better way of achieving a temporary tattoo is by decalcomania, which is the process of applying a decal to the skin. This approach allows the user to apply a preprinted image to the skin at their convenience. Decal-style tattoos are so simple to apply that even a child can use them and the image that is produced can be easily removed with soap and water. Therefore, temporary tattoos can be easily changed to suit the whims of fancy and fashion. Decal-style temporary tattoos are made by printing an image onto special paper coated with a transfer film. To apply the tattoo the user simply moistens the paper and the film slides off the backing layer carrying the image onto the skin.

### Raw Materials

### Stencil Materials

Tattoos can be made by a screen-printing process, which uses stencils to create the image to be printed. These stencils are made from nonporous paper or plastic coated with lacquer, gelatin, or a combination of glue and tusche (a heavy ink-like substance). These materials are used to block portions of the screen during the printing process so the ink only touches the paper in designated spots.

### Inks

Because temporary tattoos reside on the skin for relatively long periods of time, all colorants used in the inks must meet the same requirements as food, drug, and cosmetic colorants. These pigments, which are governed by the Food and Drug Administration (FDA), may be dispersed in water, alcohol, or oil depending on their solubility. Drying agents and extenders are also added to inks to modify their drying behavior.

### Backing Paper

Temporary tattoos may be printed on paper, plastic films, or combinations of the two. Paper is generally preferred because it is better for printing and processing. This backing paper is coated with a variety of materials using spraying or dipping methods. The coatings can be processed to a uniform thickness by passing the coated paper through a series of rollers outfitted with a knife, which evenly spreads the liquid. The paper can then be passed through a heated tunnel to accelerate drying. The first coating that is applied is typically a sizing agent, which modifies the paper's stiffness and texture. The next layer is a non-stick silicone release coating which helps the image separate from the backing paper. A transfer film is then coated on top of the silicone layer. This film is the layer that the image is printed upon and is composed of gelatin or other polymeric materials such as polyvinyl alcohol or polyvinyl pyrollidone. These materials are designed to be strong enough to adhere to the backing paper during printing yet flexible enough to be easily released during application. Upon drying on the skin, the film should adhere tightly and smoothly to maintain the image quality.

### The Manufacturing

### Process

### Stencil Preparation

An outline of the image to be printed is cut into the gelatin or lacquer layer of the stencil sheet. The lacquer or gelatin is peeled away to expose the areas to be printed. The stencil is then adhered to the screen with a solvent and, after it has dried on the screen; the backing sheet is removed leaving only the film layer. The portions of the stencil that were cut away expose a section of the screen through which ink can be forced.

### Screen Printing

The screen to which the stencil is adhered is typically made of finely woven fabrics (like silk, nylon, and Dacron) or stainless steel mesh. Image transfer is accomplished by forcing the inks through the stencil and onto the printing substrate. A rubber squeegee is used to force ink through openings in the stencil. In this process, only one color can be printed at a time, so the image must pass through the screen press once for every color. The colors are laid down in reverse order, from last to first so the finished tattoo resembles a multilayer sandwich. The bottom layer is the release paper, followed by the transfer film, topped with the detail colors. The background colors are laid down last.

### Finishing Operations

If necessary, the printed tattoo sheets can be coated with another layer of film-forming material to seal in the image. After this final coating step the sheets are cut, or slit, into rolls or individual tattoos. The finished tattoos are then wrapped or boxed for shipping. The packaging materials should be designed to minimize contact with moisture to avoid premature softening of the transfer film.

### Transfer Process

Tattoos are easily transferred from the printed sheet to skin by first lightly dampening the skin. Care must be taken not to saturate the tattoo because the film may begin to dissolve before the image is transferred. The backing paper is then firmly held against the skin either by hand or with a damp cloth or sponge. The paper must be held still to avoid shifting the image during transfer. After one to three minutes the transfer layer will soften and separate from the backing paper. The paper can then be easily peeled away, leaving the transfer film and the printed image intact on the skin. As the film dries, it bonds firmly to the skin.

### Quality Control

A number of factors affect the quality of temporary tattoos. First, the stencil must be properly prepared because dull or poor tooling will result in a murky image. Similarly, the printing screen must be carefully maintained to keep ink from clogging the pores in the screen. Inks must be correctly compounded because if they are too thick or too thin they will not pass through the screen properly. Finally, the components of the backing paper must be properly prepared.

The sizing agents, the silicone release layer, and the transfer film must all be coated evenly to minimize problems during printing and to ensure even image transfer. After manufacture is complete, the finished tattoos must be carefully packaged to exclude moisture which could cause ink bleeding or premature softening of the transfer film.

### Byproducts/Waste

The decal manufacturing process creates waste in the form of excess lacquer, gelatin, paper, and inks. Some of these waste materials may be flammable or hazardous depending on the solvents used. In many cases, paper may be recycled by repulping, a process which involves shredding the paper and mixing it with water to wash off residual coatings. The repulped paper can be cast into sheet form again and reused to make new tattoos. For all the waste that is generated, manufacturers must comply with all relevant local and federal waste disposal regulations.

With all the knowledge that is available on manufacturing these tattoos, preparing a tattoo to be affixed to the sidewall of a tire, in general, and to a pneumatic vulcanized rubber tire has proved to be quite difficult. Problems relating to the need for excessive pressure, prolonged cure times and image integrity over time have needed to be addressed in order to have an article that effectively bonds to a tire and maintains image integrity. The present invention has addressed these difficulties.

### BRIEF SUMMARY OF THE INVENTION

The present invention relates to a novel article and method for applying decorative images and accessories (including, but not limited to designs and logos) to all shapes and sizes of tires or other materials of similar composition. A process known as screen printing is used to create the tattoo image on paper coated with a transfer film. The transfer film allows the image to “slide off” the backing paper and onto a tire when moisture is applied. After a brief drying time, the image binds to the surface of the tire where is can stay on for several weeks or months or removed easily with an organic solvent which may include, but would not be limited to isopropyl alcohol or mineral oil. Additionally contemplated is a spray applied to the transferred tattoo to prolong the visible integrity of the transferred image.

In a preferred embodiment, the image is created by offset printing. Offset printing is a widely used printing technique where the inked image is transferred (or “offset”) from a plate to a rubber blanket, then to the printing surface. When used in combination with the lithographic process, which is based on the repulsion of oil and water, the offset technique employs a flat (planographic) image carrier on which the image to be printed obtains ink from ink rollers, while the non-printing area attracts a film of water, keeping the non-printing areas ink-free. Offset printing offers the added advantages of creating an image with reduced thickness and, when used in combination with the ink and adhesive of the present invention, bonds and molds more effectively to a tire.

Alternatively, the image may be made by screen printing. In screen printing a screen is made of a piece of porous, finely woven fabric stretched over a frame. Areas of the screen are blocked off with a non-permeable material to form a stencil, which is a positive of the image to be printed; that is, the open spaces are where the ink will appear.

The screen is placed atop a substrate such as papyrus or fabric. Ink is placed on top of the screen, and a fill bar (also known as a floodbar) is used to fill the mesh openings with ink. The operator begins with the fill bar at the rear of the screen and behind a reservoir of ink. The operator lifts the screen to prevent contact with the substrate and then using a slight amount of downward force pulls the fill bar to the front of the screen. This effectively fills the mesh openings with ink and moves the ink reservoir to the front of the screen. The operator then uses a squeegee (rubber blade) to move the mesh down to the substrate and pushes the squeegee to the rear of the screen. The ink that is in the mesh opening is transferred by capillary action to the substrate in a controlled and prescribed amount, i.e. the wet ink deposit is equal to the thickness of the stencil. As the squeegee moves toward the rear of the screen the tension of the mesh pulls the mesh up away from the substrate leaving the ink upon the substrate surface.

Also contemplated is a method for transferring a moisture transferable image to a tire comprising the steps of:

a. selecting a moisture transferable image that comprises ink suitable for creating an image on a tire, said image disposed on a moisture transferable backing;
b. placing the backing having said disposed image against the surface of a tire;
c. applying a necessary amount of an aqueous medium to said backing to facilitate transfer of said image;
d. holding the backing in which an aqueous medium has been applied in a fixed position for a period of time sufficient to allow complete transfer of the moisture transferable image;
e. removing the backing, wherein the removal completes the transfer of the image from the backing to the tire.

It is an object of the present invention to provide an article that provides for a moisture transferable image to be applied to a tire.

It is another object of the present invention for the moisture transferable image to comprise ink suitable for binding to the surface of a tire.

It is another object of the invention that the suitable ink bind to the surface of a tire and the moisture transferable image remain visible for up to 6 months.

### BRIEF DESCRIPTION OF THE DRAWINGS

FIG. 1 is a side view of the moisture transferable image affixed to a tire.

FIG. 2 is a side expanded view of the article.

FIG. 3 is a side perspective view of the separated layers of the article.

FIG. 4 is a top view of the article with the images shown in reverse prior to transfer.

### DETAILED DESCRIPTION OF THE PREFERRED EMBODIMENT

Article 10 has multiple layers. Clear plastic laminate 11 is placed over a moisture transferable image 13 that is disposed on releasable backing 15. Article 10 may optionally have a separate adhesive layer 12 disposed between image 13 and laminate 10. Adhesive 12 may alternatively be interdispersed within the inks forming image 13 and may facilitate affixation of image 13 to a tire side wall without the need for providing an adhesive as a separate layer. Similarly, release material layer 14 may be present as a separate layer, or may be incorporated into the surface of backing 15.

In one preferred embodiment, backing 15 is starch paper coated with a gelatin. The gelatin provides a barrier between image 13 and backing 15 and facilitates the release. Preferably, backing 15 is 2-10 mil in thickness.

Plastic laminate 11 may be any acceptable plastic laminate as in known and used in the art. However, the laminate is preferably between about 1-4 mil in thickness.

Image 13 is formed of suitable ink compositions. Suitable ink means the ink should allow for transfer of image 13 when backing 15 is wet with water or other aqueous medium. The suitable ink compositions not only bond to pneumatic rubber tires, but do so with minimum pressure and cure times and maintain image integrity for up to six months. In one embodiment, the suitable ink is a formulation having 20-30% pigment; 20-30% modified phenolic resin; 10-30% organic oil; and 15-35% hydrocarbon solvent.

The ink is insoluble in water and formulated with a suitable adhesive to bond to a rubber tire and more specifically to a vulcanized pneumatic tire. One suitable adhesive would be a rubber based adhesive having 0.1 to 5% natural rubber; 0.1 to 5% hydrogenated terphenyl; 0.1-5% isopropyl alcohol; 10-50% heptane; and 10-50% toluene.

The adhesive needs to have sufficient tack to bind to the rubber tire.

Tack is the property of an adhesive that allows it to adhere to another surface on immediate contact. It is the “stickiness” of the adhesive while in a fluid (e.g., paper cement) or semi-fluid (e.g., pressure sensitive adhesive) state. There are two stages that must be considered with this concept. The first is the wetting stage where the tacky material must wet the substrate or a probe's surface—the most common probe being the human thumb. This initial stage is controlled by physical-chemical properties, such as critical surface tension, viscosity, adhesive thickness, etc. The second stage is that of debonding the probe from the surface, and here Theological properties of the adhesive come into play.

A preferred adhesive will have a tack exhibiting 60-120 ozf/in (ounce force per inch)

Image 13 transfers after contacting backing 15 with an aqueous solution, in 1-25 seconds and cures in 1-15 minutes. In a preferred embodiment, image 13 is between about 1-5 mil thick.

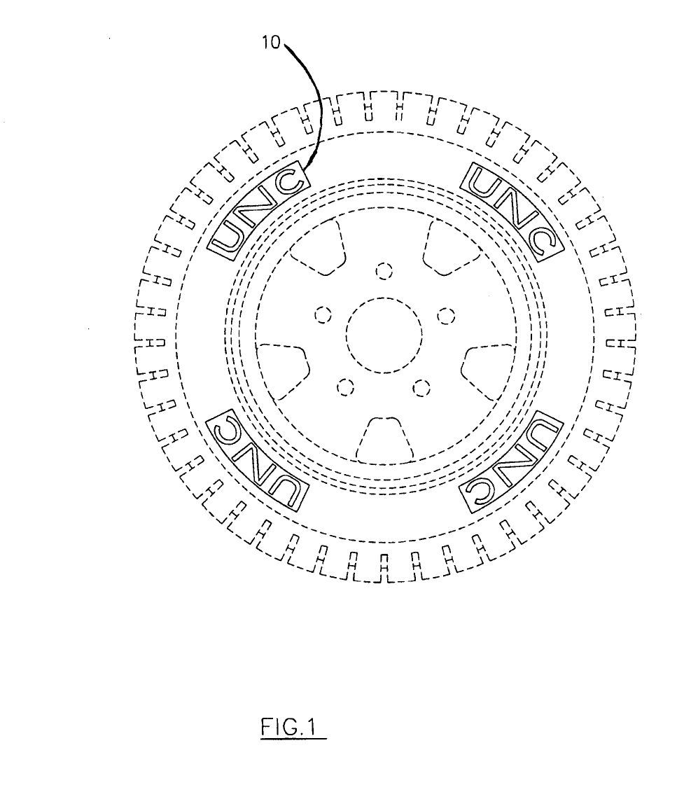

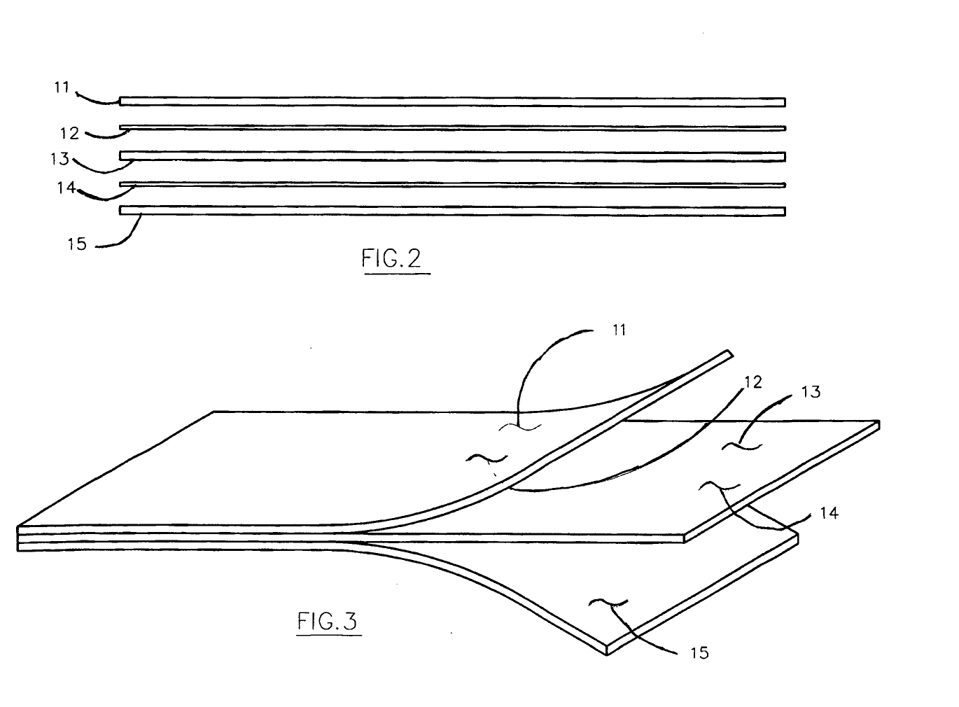

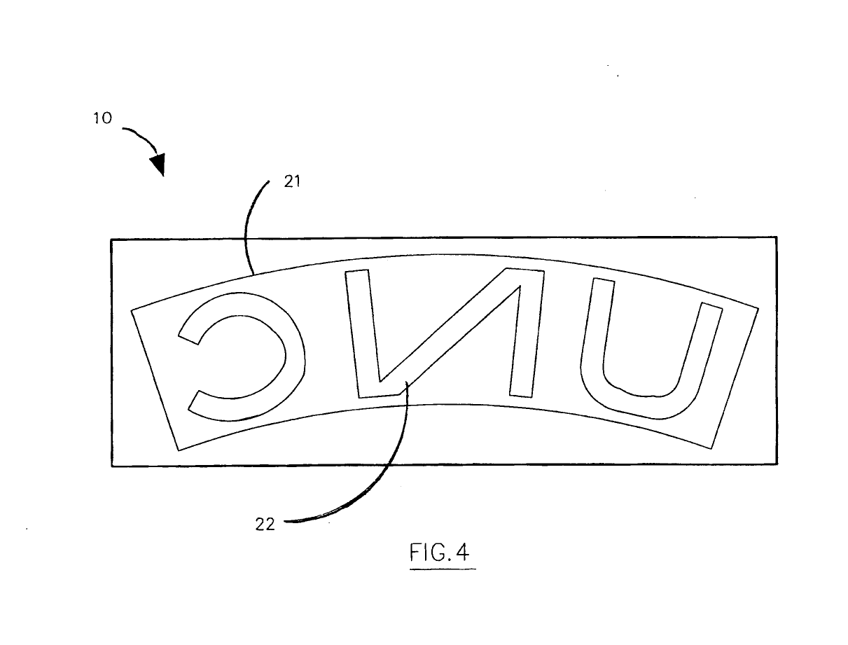

Image 13, as shown in FIG. 1, preferably has a suitable curvature so as to fit along the curvature of the selected tire.

Article 10 may have backing 15 incorporated with a silicon release coating that may further incorporate a transfer film. In a preferred embodiment, the transfer film may include, but would not be limited to gelatin, polyvinyl alcohols, and/or polyvinyl pyrollidone, or combinations thereof.

Preferably, the article imparts an image when transferred that retains visual integrity for up to six months.

The image is removable by contact with at least one organic solvent which may include, but would not be limited to isopropyl alcohol or mineral oil.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An article for imprinting a colored image on the sidewall of a tire comprising:
(a) a backing;
(b) a moisture transferable image disposed on said backing;
wherein said image comprises ink that is suitable for creating an image on a tire.

2. The article of claim 1 wherein said ink is insoluble in water.

3. The article of claim 1 wherein said tire is a rubber tire.

4. The article of claim 1 wherein said tire is a vulcanized pneumatic tire.

5. The article of claim 1 wherein said backing comprises a silicon release coating.

6. The article of claim 5 wherein said silicon release coating is further coated with a transfer film.

7. The article of claim 6 wherein said transfer film comprises gelatin, polyvinyl alcohols, and/or polyvinyl pyrollidone.

8. The article of claim 1 wherein said moisture transferable image retains visual integrity for up to six months.

9. The article of claim 1 wherein said moisture transferable image is removable by contact with at least one organic solvent.

10. The article of claim 10 wherein said organic solvent is isopropyl alcohol or mineral oil.

11. The article of claim 1 wherein said moisture transferable image has a tack value measured between 60-120 ozf/in.

12. The article of claim 1 wherein said moisture transferable image has a rubber based adhesive incorporated therein.

13. The article of claim 1 wherein said rubber based adhesive comprises 0.1-5% natural rubber.

14. A method for transferring a moisture transferable image to a tire comprising the steps of:
a. selecting a moisture transferable image that comprises ink suitable for creating an image on a tire, said image disposed on a moisture transferable backing;
b. placing the backing having said disposed image against the surface of a tire;
c. applying a necessary amount of an aqueous medium to said backing to facilitate transfer of said image;
d. holding the backing in which an aqueous medium has been applied in a fixed position for a period of time sufficient to allow complete transfer of the moisture transferable image;
e. removing the backing, wherein the removal completes the transfer of the image from the backing to the tire.
